(19) United States
(12) Patent Application Publication
(10) Pub. No.: US 2016/0295792 A1
(43) Pub. Date: Oct. 13, 2016

(54) PARTICULATE DELIVERY SYSTEM WITH MULTIPLE PARTICULATE METERS

(71) Applicant: AGCO CORPORATION, Hesston, KS (US)

(72) Inventors: Russell Secrest, Newton, KS (US); Monte J. Rans, Hesston, KS (US); Darren J. Nelson, Hutchinson, KS (US); Robert A. Matousek, Valley Center, KS (US)

(21) Appl. No.: 15/035,643

(22) PCT Filed: Nov. 25, 2014
(86) PCT No.: PCT/US2014/067217

§ 371 Date: May 10, 2016

Related U.S. Application Data
(60) Provisional application No. 61/908,228, filed on Nov. 25, 2013.

(51) Int. Cl. A01C 7/10; A01C 7/04; A01C 19/02; A01C 21/00; A01C 15/00

(52) U.S. Cl. CPC A01C 7/105; A01C 21/005; A01C 15/00; A01C 19/02; A01C 7/04

(57) ABSTRACT

A particulate delivery system for use with a mobile machine includes a particulate placement mechanism for placing particulate material in the ground in a single row as the machine travels along the ground, a plurality of particulate sources and a plurality of particulate meters. Each of the particulate meters operates independently and is configured to deliver particulate material from one of the particulate sources to the particulate placement mechanism for placement in the row. A controller may be configured to control a plurality of drive mechanisms, each drive mechanism associated with one of the particulate meters. The controller may also be configured to receive position information from a position determining device and to control operation of the drive mechanisms according to the position information and according to a field prescription.

### CROSS REFERENCE TO RELATED APPLICATION

This application claims the benefit of U.S. Provisional Application No. 61/908,228, entitled PARTICULATE DELIVERY SYSTEM WITH MULTIPLE PARTICULATE METERS, filed Nov. 25, 2013, which is hereby incorporated by reference in its entirety.

### BACKGROUND OF THE INVENTION

1. Field of Invention

This invention relates generally to agricultural machines for placing particulate material on or below a ground surface.

2. Description of Related Art

Agricultural particulate delivery machines include row crop planters, grain drills, fertilizer spreaders and the like. Row crop planters include multiple row planting units (or simply “row units”) attached to a toolbar and towed behind a tractor. Each of the row units is responsible for opening a furrow, dispensing seeds into the furrow, and closing the furrow after the seeds are placed. By way of example, the seed furrows may be opened by a first pair of disks extending downwardly from the row unit at its leading end, closed by a second pair of disks extending downwardly from the row unit at its trailing end, and then tamped or packed down by a trailing wheel that follows both pairs of disks. Row crop planters and other types of planters may include mechanisms for placing fertilizer pellets or other particulate material in or on the ground along with the seeds.

Each of the row units generally includes a particulate metering system and a particulate placement mechanism. The metering system includes a particulate source, such as a bin for storing seeds or other particulate material, and a metering mechanism for isolating small amounts of particulate material from the source and delivering the particulate material to the placement mechanism, a process sometimes referred to as “singulation.” Seed metering systems, for example, may employ seed plates, finger plates or seed discs to isolate individual seeds and deliver the seeds to the placement mechanism. The placement mechanism may use gravity drop or power drop mechanisms to place particulate material in the furrow.

The spacing and depth of particulate material placement may vary from one application to another. Thus, particulate placement machines typically include mechanisms for allowing an operator to control such factors as placement density and depth. A row crop planter, for example, may have a depth adjustment mechanism associated with each row unit that allows an operator to set the planting depth of that row unit. Furthermore, operation of the particulate meters may be adjusted to control the spacing/density of the particulate material in the furrow.

The above section provides background information related to the present disclosure which is not necessarily prior art.

### SUMMARY

A particulate delivery system constructed in accordance with an embodiment of the present invention comprises a particulate placement mechanism for placing particulate material in the ground in a single row as the machine travels along the ground, a plurality of particulate sources and a plurality of particulate meters. Each of the particulate meters operates independently of the other particulate meter or meters and is configured to deliver particulate material from one of the particulate sources to the particulate placement mechanism for placement in the row.

A particulate delivery system constructed in accordance with another embodiment of the invention comprises a plurality of row units and a meter control system. Each of the row units includes a particulate placement mechanism for placing particulate material in the ground in a single row, a plurality of separate particulate sources, a plurality of particulate meters and a plurality of drive mechanisms. Each of the particulate meters is configured to deliver particulate material from one of the particulate sources to the placement mechanism for placement in the row. Each of the drive mechanisms is configured to drive operation of one of the particulate meters.

The meter control system includes a power source connected to each of the drive mechanisms and a controller in communication with each of the drive mechanisms. The controller is configured to communicate control signals to each of the drive mechanisms separately from the other drive mechanisms such that each drive mechanism operates independently of the other drive mechanisms.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### DRAWINGS

Embodiments of the present invention are described in detail below with reference to the attached drawing figures, wherein:

FIG. 1 is a block diagram of an exemplary machine communication and control system that may be used in accordance with embodiments of the invention.

FIG. 2 is a block diagram of another exemplary machine communication and control system that may be used in accordance with embodiments of the invention.

FIG. 3 is a perspective view of an exemplary machine including a particulate delivery system constructed in accordance with embodiments of the invention.

FIG. 4 is a perspective view of a row unit of the machine of FIG. 3.

FIG. 5 is a perspective view of certain components of the row unit of FIG. 4.

FIG. 6 is an exploded view of certain components of the row unit of FIG. 4.

FIG. 7 is a block diagram illustrating certain components of a communication and control system used to control operation of a plurality of row units of the machine of FIG. 3.

FIG. 8 is a fragmentary plan view of an agricultural field.

FIG. 9 illustrates a field prescription corresponding to a portion of the field of FIG. 8.

FIG. 10 illustrates a portion of the field of FIG. 8, showing two areas defined by the prescription and a working path of a particulate delivery machine passing through the areas.

FIG. 11 illustrates another portion of the cultivated area of the field of FIG. 8, showing two areas defined by the prescription and a working path of a particulate delivery machine passing through the areas.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etcetera described in one embodiment may also be included in other embodiments, but is not necessarily included. Thus, the present technology can include a variety of combinations and/or integrations of the embodiments described herein.

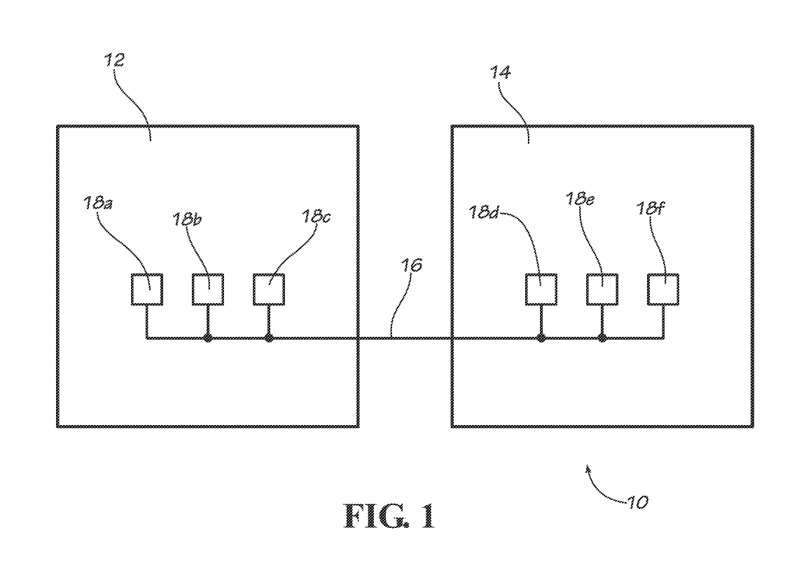

Embodiments of the present invention may use or involve communications and control systems associated with one or more agricultural machines. A block diagram of an exemplary machine communication and control system 10 is illustrated in FIG. 1. The exemplary communication and control system 10 spans both a tractor 12 and an implement 14 associated with the tractor 12, enabling communication and control between components of the tractor 12, between components of the implement 14, between components of the tractor 12 and components of the implement 14, and/or between components of two or more implements. It will be appreciated that the communication and control system 10 may be associated with only one machine, such as only a tractor, or may be associated with more than two machines, such as the tractor 12 and two or more implements mounted on or connected to the tractor.

The system 10 includes a communications medium 16 and a plurality of components 18 communicatively coupled via the communications medium 16. The communications medium 16 may include one or more physical media through which signals are propagated or otherwise communicated according to protocols governing the exchange of information between components. By way of example, the communications medium 16 may include wired and/or wireless transmission paths configured to carry signals between the components 18, such as electrical, optical, or electromagnetic signals. The communications medium 16 may include a data bus configured to communicate digital or analog signals in serial or parallel format according to any of various protocols, including protocols associated with proprietary or open standards. Specifically, in some embodiments the system 10 may conform to the ISO 11783 standard, discussed below.

The components 18 communicatively coupled with the communications medium 16 may include, without limitation, controllers, display devices, sensors and actuators. By way of example, one or more of the components 18 may be associated with the tractor engine, one or more of the components may be associated with the tractor transmission, one or more of the components may be associated with the tractor dashboard, and one or more of the components may be associated with the tractor hydraulic system. Similarly, one or more of the components 18 may be associated with each of various functions and/or components of an implement associated with the tractor. If the implement is a planter, for example, one or more of the components may be associated with a seed flow sensor or other element of each row unit.

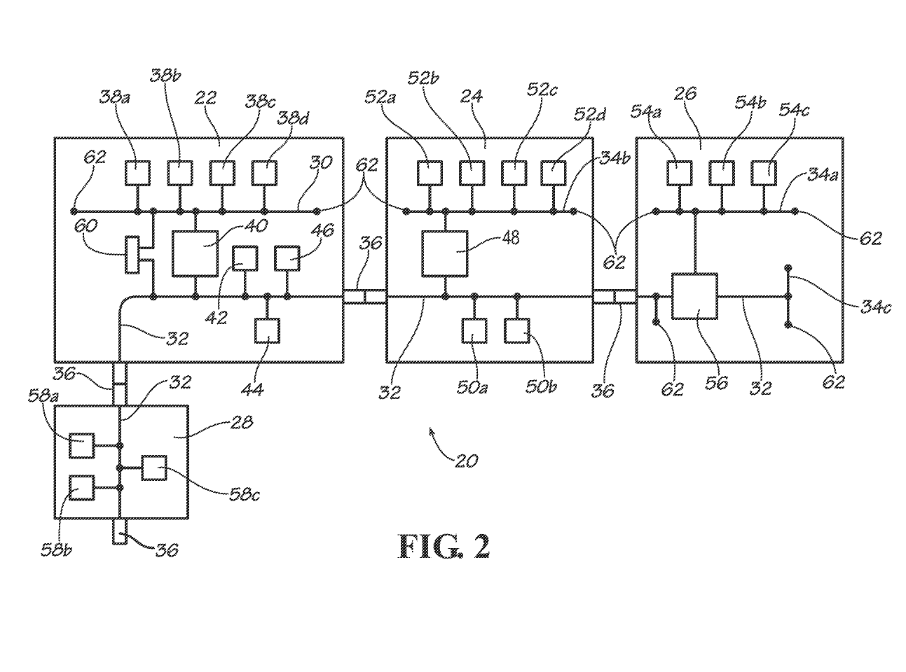

With reference to FIG. 2, another exemplary machine control and communications system 20 is illustrated in greater detail. The communication and control system 20 conforms to the International Standard Organization's ISO 11783 standard, also referred to herein as the “Isobus standard” or simply “Isobus.” The Isobus standard is designed to enable the electrical systems of different agricultural machines to interact, regardless of the type of machine or the manufacturer. More specifically, Isobus standardizes the method and format of data transfer between sensors, actuators, control elements, and information storage and information display units, whether mounted on, or part of, a tractor or one or more implements. In use, when the operator of an Isobus-enabled tractor attaches an Isobus-enabled implement such as a sprayer or seeder to the tractor, the operator establishes an Isobus connection by physically attaching a connector of the implement to a connector of the tractor. Once the physical connection is established, the electrical systems of both machines automatically begin exchanging communication and control information. During operation the tractor may communicate speed information to the implement, for example, and the implement may communicate performance and status information to the tractor for presentation to the operator via a virtual terminal.

The Isobus standard defines various aspects of the control and communication system including physical interconnections, network communication layers and network management, messaging, a task controller, diagnostics and even a standardized computer file server. Isobus uses a shared wiring concept that allows tractor and implement controllers to efficiently communicate over a single pair of wires, reducing the complexity of the system and the risk of failure. Isobus systems do not use a centralized controller, but rather allow multiple controllers (called electronic control units or “ECUs”) to access the bus simultaneously, using a prioritized transmission process to grant access to the bus. All networked electronics can be diagnosed through one connection to the bus.

Isobus systems may use the Controller Area Network (CAN) protocol defined in the ISO 11898 standard for physical and data link layer communications. The CAN protocol allows multiple controllers within a machine or system to communicate with each other without the need for a host computer or other single master controller. Devices attached to a CAN network typically include sensors, actuators and other control devices. Such devices may include a host processor and a CAN controller connected to a CAN communications bus.

In the illustrated embodiment, the system 20 is associated with a tractor 22 and a plurality of implements 24, 26, 28 associated with the tractor 22, including two rear-mounted or towed implements 24, 26 and a front- or side-mounted implement 28. Isobus generally supports two network segments, including a tractor network 30 and an implement network 32, that can each include one or more subnetworks 34. As used herein, the term “tractor” broadly refers to the main power unit of a system and, therefore, may be a tractor according to the conventional meaning of the word or may be another machine that serves as the main power unit of a system. By way of example, a combine harvester pulling a grain wagon or other machine may be a “tractor” in an Isobus-enabled system.

The tractor network 30 provides the control and data communications for the drive train and chassis of the tractor 22 and connects to components 38 associated with the engine, the transmission, brakes and a hitch controller. The particular components and implementation details of the tractor network 30 are typically determined by the tractor manufacturer. The implement network 32 enables control and data communications between two or more implements and between the tractor and one or more implements. The implement network 32 spans the tractor 22 as well as the plurality of implements 24, 26, 28 and may be interconnected between the tractor and the various implements via breakaway connectors 36. Both the tractor network 30 and a portion of the implement network 32 may be built into the tractor's systems by the original manufacturer. A tractor ECU 40 is part of both the tractor network 30 and the implement network 32 and provides electrical and logical/message isolation between the two networks. By way of example, the tractor ECU 40 receives and interprets requests from the implement network 32 and communicates with one or more ECUs on the tractor network 30 to respond to the requests. Each implement 24, 26, 28 provides connections for extending the implement network 32 to additional implements that would be connected in a serial manner. The portion of the implement network 32 implemented on the tractor may also include a virtual terminal device 42, a management computer gateway 44 and a task controller 46.

The virtual terminal device 42 provides an operator interface for the tractor 22 and any implements connected to the tractor 22 using standardized control and messaging associated with the Isobus network. In the illustrated embodiment, the virtual terminal device 42 is connected to the implement network 32 on the tractor 22, but the tractor ECU 40 and other ECUs in the tractor 22 that are connected to the tractor network 30 can also access and use the virtual terminal 42. When an Isobus-compliant implement is connected to the tractor 22, the virtual terminal device 42 detects the presence of the implement and downloads virtual terminal data unique to that implement from an ECU on board the implement. The virtual terminal device 42 uses the virtual terminal data to generate a touchscreen with buttons, tabs, indicators and/or other elements associated with the implement. Each implement may provide its own virtual terminal data, and if multiple implements are connected to the Isobus system the operator may toggle a display of the device 42 between the various implements. Each Isobus-ready implement includes all of the data needed to operate its various functions electronically using an Isobus-compliant terminal in the cabin of the tractor 22. By way of example, an operator may raise and lower the pickup on a bailer or forage wagon using the virtual terminal 42, or may open and close the hopper slides on a fertilizer spreader.

Isobus virtual terminals have a common display format—they use the same style to show an implement's settings, they are adjusted in the same way and the graphical representation of various functions has the same look and feel on every terminal. Virtual terminals for a fertilizer spreader and a forage wagon will have different functional content, for example, but they are similar enough in look, feel and structure that an operator with experience operating one will feel comfortable operating the other with little or no preparation or instruction. The device 42 may be portable such that it may be moved from one machine to another.

The task controller 46 enables scheduled control of implement functions via the Isobus network. Task data received via the management computer gateway 44 is stored in the task controller 46, which then schedules the tasks and sends control messages to the appropriate control function for execution on the implement network 32. The task controller 46 also records data received from the control functions as tasks are being completed. This data is communicated back to a farm management computer through the management computer gateway 44. Thus, the management computer gateway 44 provides an interconnection between the Isobus system and the external farm management computer.

The implement 24 includes a portion of the implement network 32 and a subnetwork 34b interconnected via a network interconnect unit 48. Each of the implement network 32 and the implement subnetwork 34b includes a plurality of ECUs and/or other components 50, 52. The network interconnect unit 48 may be required to maintain network electrical load limits if the subnetwork 34b includes a large number of nodes. The implement 26 also includes a portion of the implement network 32, an Isobus subnetwork 34a with associated components 54 (e.g., ECUs, lighting controllers, etcetera), and a second subnetwork 34c associated with a different standard, both connected to the implement network 32 via a network interconnect unit 56. Thus, the network interconnect unit 56 may be used to isolate and bridge network segments with different architectures. The implement 28 includes a plurality of ECUs or other components 56 connected to the implement bus 32.

The system 20 may further include a diagnostic connector 60 and a plurality of bus terminators 62. Other components, such as a power source or connector, are not illustrated. Many aspects of Isobus systems are determined by machine manufacturers and will vary from one system to another.

In an exemplary scenario, a tractor and a sprayer are Isobus-enabled. The tractor and the sprayer may be made by different manufacturers, but when the sprayer is connected to the tractor's Isobus system the sprayer's virtual terminal appears on the virtual terminal 42. The operator can then read flow meters, change rates and operate control valves via the virtual terminal inside the tractor's cab. The operator can also raise or lower spray boom sections, turn sections of the boom on and off, and map the spray application using a GNSS-enabled device.

The control and communications system 20 is an example of an Isobus-compliant system that may form part of and/or may be used by embodiments of the present invention. The control and communications system 20 may vary substantially from one embodiment of the invention to another, and may or may not be Isobus compliant, without departing from the spirit or scope of the invention.

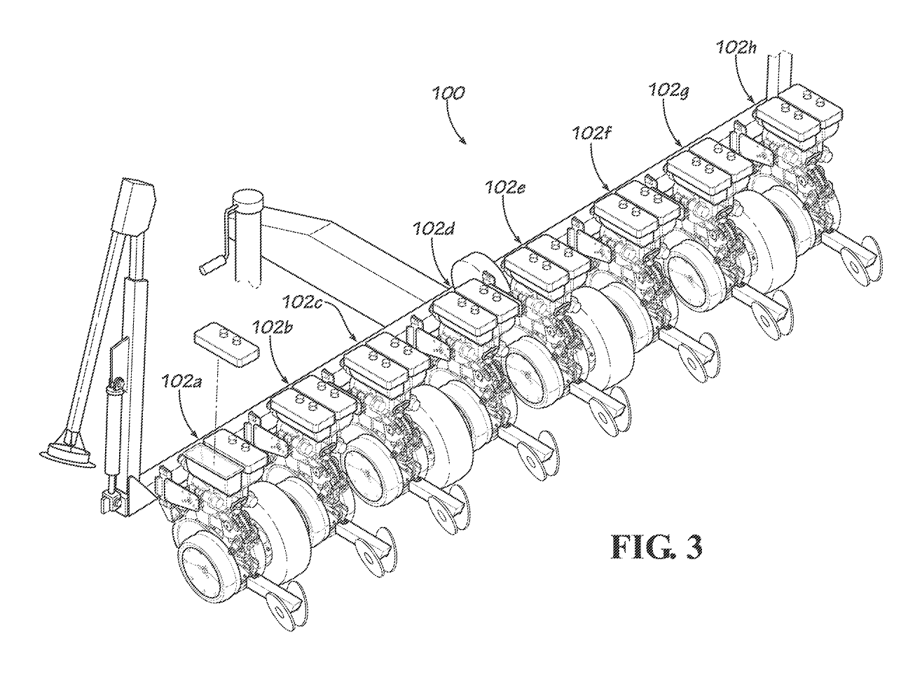

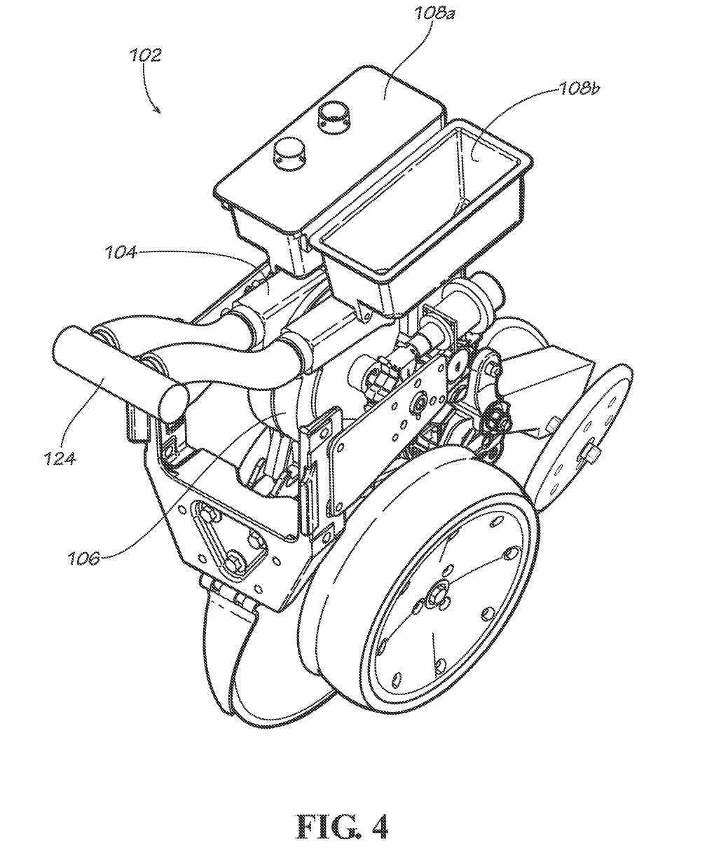

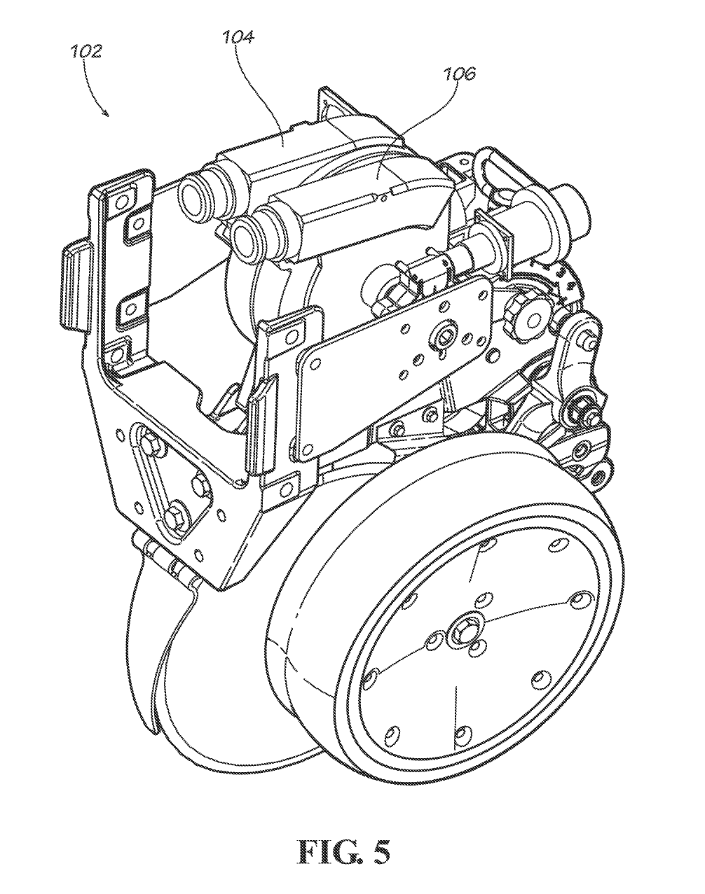

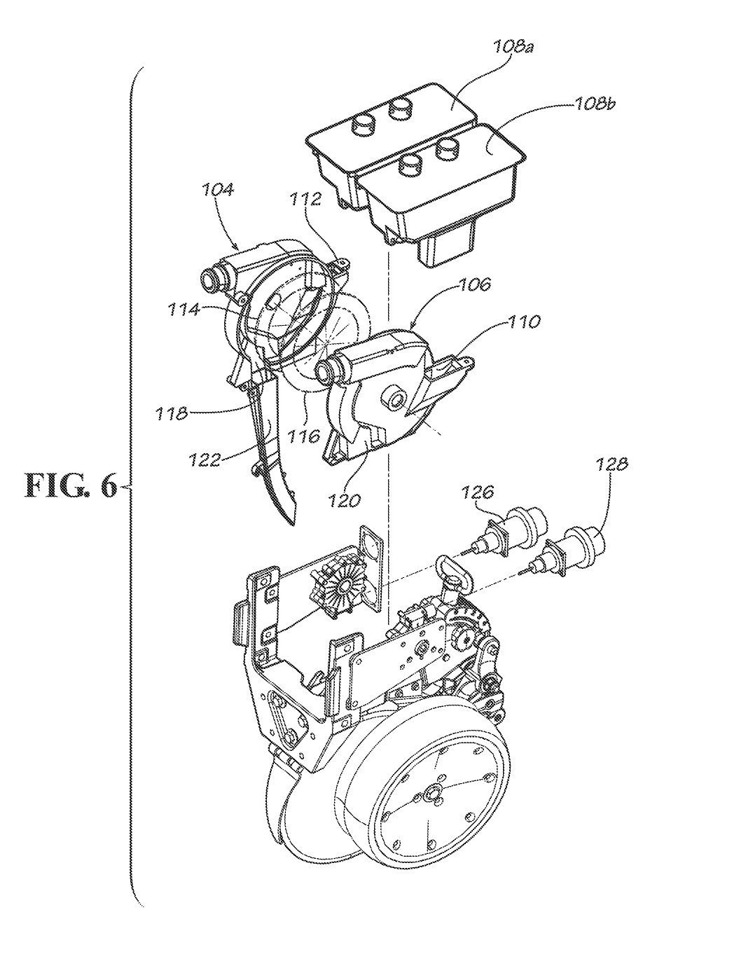

Turning now to FIGS. 3-7, a machine 100 constructed in accordance with embodiments of the invention is illustrated. The machine 100 includes a plurality of row units 102 each configured to place particulate material in a single row on or in the ground as the machine travels along the ground. Each of the illustrated row units 102 includes mechanisms for opening a furrow, placing the particulate material in the furrow, and closing the furrow as is known in the art. Each unit 102 also includes a particulate metering system and a particulate placement mechanism, the particulate placement mechanism adapted to receive particulate material from the metering system and place the particulate material in the furrow.

The particulate metering system associated with each row unit 102 includes a plurality of meters 104, 106 for regulating flow of particulate material from a plurality of particulate sources 108 to the particulate placement mechanism. In one embodiment, the particulate meters 104, 106 are forced air type meters each including a particulate inlet 110, 112, a metering disc 114, 116 for singulating particulate material from the inlet and transferring the particulate material to a particulate outlet 118, 120, and a drop tube 122 that directs particulate material from the outlets 118, 120 into a furrow created by the row unit 102. A forced air system 124 may provide air flow into each of the meters 104, 106.

The particulate sources 108 may include one-eighth bushel hoppers, as illustrated, configured to receive particulate material from a central fill system. Other types of sources may be used without departing from the scope of the invention. By way of example, the particulate sources 108 may include larger hoppers, such as bushel-sized hoppers, that are not adapted for use with a central fill system. Each of the particulate sources 108a, 108b may contain a different particulate material, such as where a first source 108a contains a first type of seed and a second source 108b contains a second type of seed, or where the first source 108a may contain seed while the second source 108b contains fertilizer. Because each of the two meters 104, 106 receives particulate material from a different particulate source 108a, 108b, two different types of particulate material may be placed in a single furrow, and each type of material may be metered at different times, at different rates, or both.

A drive mechanism 126, 128 is associated with each of the meters 104, 106 and is configured to drive operation of the respective meter, such as by rotating the seed disc 114, 116. Each of the drive mechanisms 126, 128 operates independently of the other drive mechanism 128, 126 on the same row unit 102 and independently of all of the other row units 102. As explained below in greater detail, this allows each of the meters 104, 106 to be operated independently of the other meters for precisely regulated placement of particulate material.

Each of the drive mechanisms 126, 128 may include an electrical motor or other actuator and a drive controller for receiving and interpreting control signals communicated from a control unit and for driving operation of the motor according to the control signals. The control unit may communicate control signals, for example, in the form of digital data packets wherein each of the drive controllers is configured to receive and decode the digital data packets.

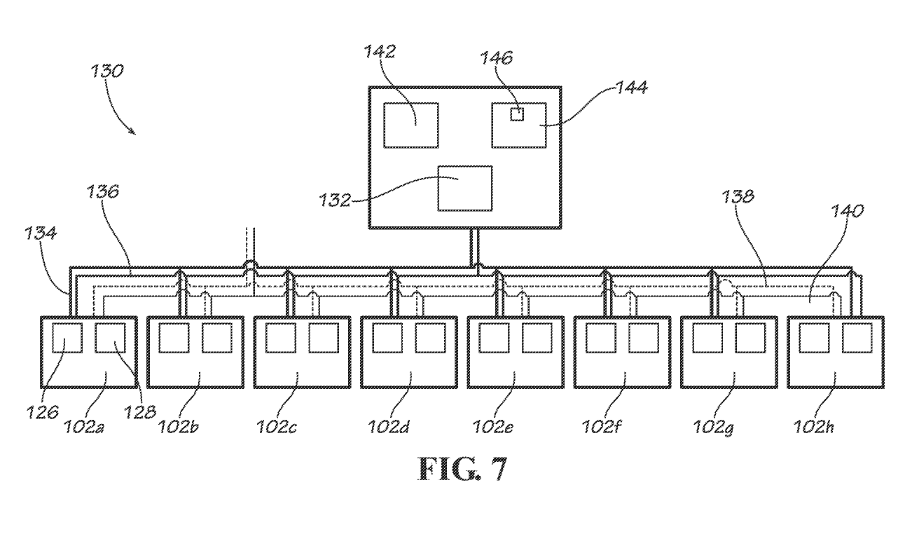

With particular reference to FIG. 7, an exemplary control system 130 for controlling operation of the meters 104, 106 is illustrated. Each of the row units 102 is communicatively coupled with a control unit 132 via a data bus including a pair of wires 134, 136. The control unit 132 may be located either on the implement or on a tractor pulling the implement. The system 130 also includes a pair of conductors 138, 140 for carrying electrical power to each of the row units 102 to energize the drive mechanisms 126, 128. The conductors 138, 140 connect to a power source (not illustrated), such as a tractor's electrical system, and may provide a constant source of power to the drive mechanisms. Thus, in one embodiment, operation of the drive mechanisms 126, 128 is not controlled by regulating power delivery to the drive mechanisms, but rather is controlled via control signals communicated from the control unit 132. The control system 130 may conform to the ISO 11783 standard and/or the ISO 11898 standard, described above.

The control unit 132 may be configured to communicate a variety of unique control signals or instructions to each of the drive mechanisms 126, 128. The control unit 132 may cause one of the meters 104, 106 to meter particulate material while the other one of the meters 104, 106 is stationary and does not meter particulate material. The control unit 132 may also cause both of the particulate meters 104, 106 to operate simultaneously, wherein particulate material from both sources 108a, 108b is placed in the furrow simultaneously. This scenario may be used, for example, to place fertilizer in the furrow along with seeds. When operating both meters 104, 106 simultaneously, the control unit 132 may adjust the speed of one or both of the meters 104, 106 to thereby adjust the rate at which particulate material is placed in the furrow. It may be desirable, for example, to adjust the placement density of seeds, of fertilizer or both as the machine 100 travels through different portions of the field.

The control system 130 described and illustrated herein is set forth as one example of a system for controlling operation of the particulate meters 104, 106, with the understanding that various types of control methods and systems may be used without departing from the spirit or scope of the present invention. Alternative control systems may use regulated electrical power delivery, hydraulic components and/or mechanical linkages, for example, to independently actuate each of the particulate meters 108 and are within the ambit of the present invention.

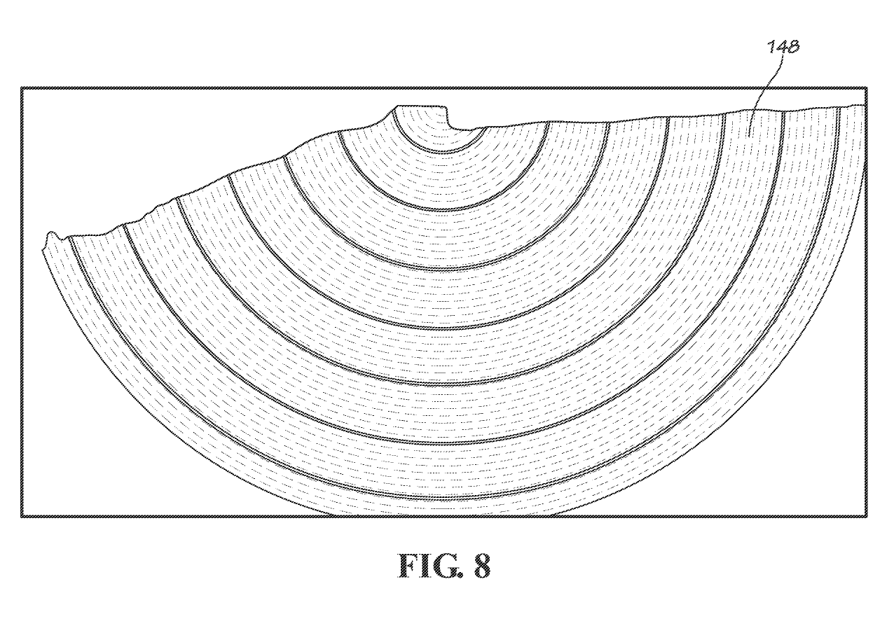

The control system 130 may further include a position determining device 142 and a storage component 144 capable of storing one or more field prescriptions 146. The position determining device 142 is configured to determine a location of the machine 100 and communicate location information to the control unit 132. The location determining device 142 may be or include, for example, a GPS receiver. The control unit 132 may use the position information and a field prescription to selectively apply different particulate material to different areas of a field which may be necessitated by, for example, different growing conditions in the different areas. FIG. 8, for example, is a plan view of a portion of a field 148. Different areas of the field 148 may present different growing conditions and, therefore, may require different types or amounts of seeds, fertilizer and/or other chemicals or additives. The soil in some areas of the field may have a lower moisture content than the soil in other parts of the same field due, for example, to irregularities in an irrigation system, to the presence of a stream or other water source, or to topographic characteristics of the field. Additionally, some areas of the field may receive more sunlight than other areas of the field. These and other factors may contribute to differences in growing conditions at different areas of the field.

Because the growing conditions can vary from one part of a field to another as explained above, it may be desirable to apply different types or different combinations of particulate material to the different areas of the field, or to place particulate material in greater or lesser density in different areas of the field. It may be desirable to plant a first type of seed in a first portion of the field, for example, and to plant a second type of seed in a second portion of the field. As another example, it may be desirable to supplement seeds with fertilizer at a first application rate in a first part of the field and at a second rate in a second part of the field or to plant seeds at a greater density in a first part of the field.

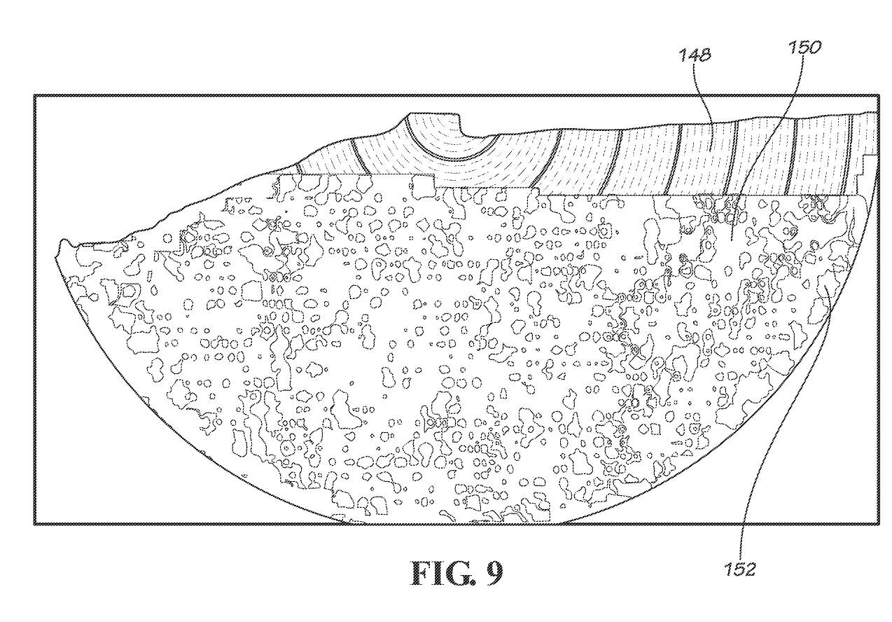

An exemplary prescription for the field 148 is illustrated graphically in FIG. 9 superimposed over a portion of the field 148, wherein different prescription requirements are indicated by different graphical elements in the figure. A first area 150 (not enclosed) may correspond to an area designated to receive a first type of particulate material and a second area 152 (enclosed) may correspond to an area designated to receive a second type of particulate material. By way of example, the first area 150 may be designated for planting a first kind of seed and the second area 152 may be designated for planting a second kind of seed.

The control unit 132 may use a field prescription such as the one illustrated in FIG. 9 to apply different types, amounts or combinations of particulate material to the field 148 at different locations. As the machine 100 moves through the field 148, for example, the location determining device 142 provides location information to the control unit 132 indicating a current location of the machine 100. The control unit 132 compares the current location with the prescription to determine in which area of the field 148 the machine 100 is currently located and the prescription for that area.

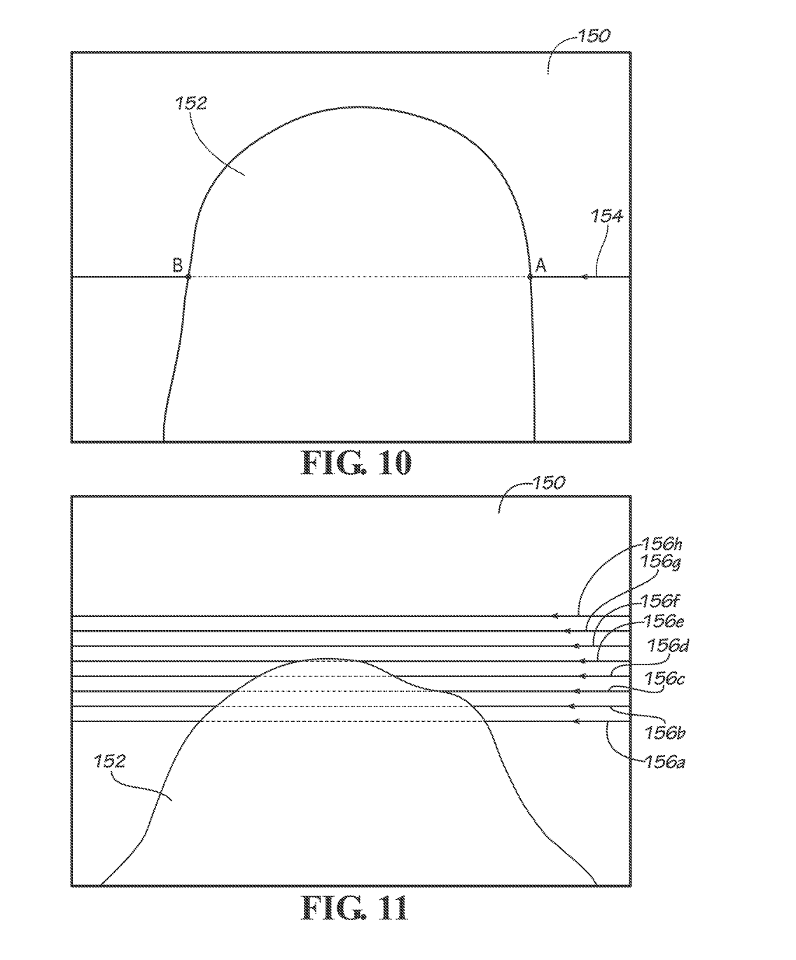

In one exemplary scenario, the system may be used to plant two different types of seeds in a field according to a field prescription, wherein a first seed is planted in a first area or series of areas and a second seed is planted in a second area or series of areas. A small portion of the field 148 is illustrated in FIG. 10 presenting two areas 150, 152 separated by a geographically-defined boundary. As the field 148 is worked the machine 100 passes through the field along line 154 in the direction indicated by the arrow. As the machine 100 passes from the first area 150 to the second area 152 at point A, the control unit 132 stops operation of a first particulate meter and starts operation of a second particulate meter so that a first type of seed is planted in the first area 154, as indicated by the solid line, and a second type of seed is planted in the second area 152, as indicated by the broken line. As the machine 100 passes from the second area 152 back to the first area 150 at point B, the control unit 132 stops operation of the second meter and starts operation of the first meter.

It will be appreciated that the change in particulate delivery can occur instantaneously with little or no disruption of the supply of particulate material and without the need for the tractor to slow or otherwise disrupt operations. Each of the particulate meters 104, 106 may contain a full load of particulate material such that particulate material begins entering the drop tube 122 immediately when the particulate meter begins to operate and stops immediately when the particulate meters stops operating. Furthermore, the control unit 132 may make the changes automatically without input from the operator, allowing the operator to focus on other aspects of the operation.

Because each of the drive mechanisms 126, 128 is controlled independently of the other drive mechanisms each row unit 102 may be switched between delivery options independently of the other row units. As illustrated in FIG. 11, as the machine 100 travels through a field some of the row units will encounter a boundary before other row units and some of the units may not encounter the boundary at all. As the machine 100 moves in the direction of the arrows in FIG. 11, for example, rows 156a and 156b will encounter the boundary before row 156c, which will encounter the boundary before row 156d, and so forth. Three of the rows, 156f-h do not encounter the boundary at all in this pass through the field. The control unit 132, using the position determining device 142 and the field prescription 146, operates each of the meters 104, 106 to place the first type of particulate material in the first area 150 and the second type of particulate material in the second area 152.

Although the invention has been described with reference to the preferred embodiment illustrated in the attached drawing figures, it is noted that equivalents may be employed and substitutions made herein without departing from the scope of the invention as recited in the claims. By way of example, the particulate meters 104, 106 may be contained in separate housing or integrated into a single device with one, unitary housing. Furthermore, some components of the control system 130 may be located remotely from the machine 100, such as where the control unit 132 and/or the memory 144 are located on an remote computer system and accessed via a communications link.

Having thus described the preferred embodiment of the invention, what is claimed as new and desired to be protected by Letters Patent includes the following:

1. A particulate delivery system for use with a mobile agricultural machine, the particulate delivery system comprising:
a plurality of row units, each row unit comprising:
a plurality of particulate sources comprising at least a first particulate source and a second particulate source;
a particulate placement mechanism for placing particulate material in the ground in a single row;
a plurality of particulate meters comprising at least a first particulate meter configured to deliver particulate material from the first particulate source to the particulate placement mechanism for placement in the single row, and a second particulate meter configured to deliver particulate material from the second particulate source to the particulate placement mechanism for placement in the single row;
a plurality of meter drive mechanisms comprising at least a first meter drive mechanism being configured to drive operation of the first particulate meter, and a second meter drive mechanism being configured to drive operation of the second particulate meter;
a meter control system comprising:
a power source connected to each of the plurality of drive mechanisms on each of the plurality of row units; and
a controller in communication with each of the plurality of meter drive mechanisms on each of the plurality of row units, the controller configured to communicate control signals to each of the first meter drive mechanisms separately from the second meter drive mechanisms such that the first meter drive mechanism operates independently of the second meter drive mechanism on each of the plurality of row units.

2. The particulate delivery system as set forth in claim 1, the meter control system further including:
a first plurality of wires providing data communications between the controller and the plurality of meter drive mechanisms on each of the plurality of row units, and
a second plurality of wires providing power to each of the plurality of meter drive mechanisms from the power source, the second plurality of wires being electrically isolated from the first plurality of wires.

3. The particulate delivery system as set forth in claim 1, the power source providing substantially constant, uniform power to each of the plurality of meter drive mechanisms regardless of the operating state of the plurality of meter drive mechanisms.

4. The particulate delivery system as set forth in claim 1, further comprising a position determining device, the controller being configured to communicate control signals to the plurality of meter drive mechanisms according to a field prescription and according to position information received from the position determining device.

5. The particulate delivery system as set forth in claim 4, the controller being configured to communicate control signals to the drive mechanisms to operate each of the drive mechanisms individually and according to the field prescription.

6. The particulate delivery system as set forth in claim 5, the field prescription including a first area of the field and a second area of the field, the controller configured to communicate control signals to the drive mechanisms to thereby control the particulate meters to place a first particulate material in the first area of the field and to place a second particulate material in the second area of the field.

7. The particulate delivery system as set forth in claim 1, each of the plurality of meter drive mechanisms configured to receive digital communications in conformance with an ISO 11898 standard and to drive operation of one of the particulate meters according to instructions contained within the communications.

8. The particulate delivery system as set forth in claim 1, each of the plurality of meter drive mechanisms configured to receive digital communications in conformance with an ISO 11783 standard and to drive operation of one of the particulate meters according to instructions contained within the communications.

9. The particulate delivery system as set forth in claim 1, each of the plurality of meter drive mechanisms configured to hold its respective particulate meter in a stationary state wherein the meter does not dispense particulate material, and to drive the meter at a first speed to dispense particulate material at a first rate, and to drive the meter at a second speed to dispense particulate material at a second rate.

10. The particulate delivery system as set forth in claim 1, the controller configured to control operation of each of the plurality of meter drive mechanisms individually and independently.

11. The particulate delivery system as set forth in claim 1, each of the particulate meters configured to start and stop placing particulate material in the particulate placement mechanism upon receiving start and stop instructions from the controller.

12. The particulate delivery system as set forth in claim 11, the controller configured to control operation of the plurality of particulate meters to stop delivery of a first particulate material and to start delivery of a second particulate material in the row without interrupting the flow of material to the placement mechanism.

13. The particulate delivery system as set forth in claim 1, the plurality of particulate meters configured to operate one at a time and simultaneously.
